(19) United States
(12) Patent Application Publication
(10) Pub. No.: US 2019/0053136 A1
(43) Pub. Date: Feb. 14, 2019

(54) TECHNIQUES AND APPARATUSES FOR 5TH GENERATION ICON DISPLAY FOR A SHARED BASE STATION

(71) Applicant: QUALCOMM Incorporated, San Diego, CA (US)

(72) Inventors: Kuo-Chun Lee, San Diego, CA (US); Arvind Santhanam, San Diego, CA (US); Srinivasan Balasubramanian, San Diego, CA (US); Reza Shahidi, San Diego, CA (US); Aziz Gholmieh, Del Mar, CA (US); Leena Zacharias, San Jose, CA (US); Yue Yang, San Diego, CA (US); Yongsheng Shi, San Diego, CA (US); Keiichi Kubota, San Diego, CA (US)

(21) Appl. No.: 16/045,406

(22) Filed: Jul. 25, 2018

Related U.S. Application Data
(60) Provisional application No. 62/543,651, filed on Aug. 10, 2017.

(51) Int. Cl. H04W 48/16; H04L 5/00; H04L 1/16; H04W 72/04; H04W 88/06; H04W 16/14

(52) U.S. Cl. CPC H04W 48/16; H04L 5/005; H04L 1/1614; H04W 84/042; H04W 88/06; H04W 16/14; H04W 72/0406

(57) ABSTRACT

Certain aspects of the present disclosure generally relate to wireless communication. In some aspects, a user equipment may determine that a base station, associated with a first radio access technology, is shared between one or more operator networks of a second radio access technology; and display an icon corresponding to the second radio access technology based at least in part on a particular operator network, of the one or more operator networks, being a registered operator network of the user equipment and being associated with the second radio access technology. Numerous other aspects are provided.

### CROSS-REFERENCE TO RELATED APPLICATIONS UNDER 35 U.S.C. § 119

This application claims priority to U.S. Provisional Patent Application No. 62/543,651, filed on Aug. 10, 2017, entitled “TECHNIQUES AND APPARATUSES FOR 5TH GENERATION ICON DISPLAY FOR A SHARED BASE STATION,” which is hereby expressly incorporated by reference herein.

### FIELD OF THE DISCLOSURE

Aspects of the present disclosure generally relate to wireless communication and to techniques and apparatuses for 5th Generation (5G) icon display for a shared base station.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method for wireless communication performed by a user equipment may include determining that a base station, associated with a first radio access technology, is shared between one or more operator networks of a second radio access technology; and/or displaying an icon corresponding to the second radio access technology based at least in part on a particular operator network, of the one or more operator networks, being a registered operator network of the user equipment and being associated with the second radio access technology.

In some aspects, a user equipment for wireless communication may include one or more processors configured to determine that a base station, associated with a first radio access technology, is shared between one or more operator networks of a second radio access technology; and/or display an icon corresponding to the second radio access technology based at least in part on a particular operator network, of the one or more operator networks, being a registered operator network of the user equipment and being associated with the second radio access technology.

In some aspects, a non-transitory computer-readable medium may store one or more instructions for wireless communication. The one or more instructions, when executed by one or more processors of a user equipment, may cause the one or more processors to determine that a base station, associated with a first radio access technology, is shared between one or more operator networks of a second radio access technology; and/or display an icon corresponding to the second radio access technology based at least in part on a particular operator network, of the one or more operator networks, being a registered operator network of the user equipment and being associated with the second radio access technology.

In some aspects, an apparatus for wireless communication may include means for determining that a base station, associated with a first radio access technology, is shared between one or more operator networks of a second radio access technology; and/or means for displaying an icon corresponding to the second radio access technology based at least in part on a particular operator network, of the one or more operator networks, being a registered operator network of the apparatus and being associated with the second radio access technology.

Aspects generally include a method, apparatus, system, computer program product, non-transitory computer-readable medium, user equipment, wireless communication device, and processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with certain aspects of the present disclosure.

FIG. 2 is a block diagram conceptually illustrating an example of a base station in communication with a user equipment (UE) in a wireless communication network, in accordance with certain aspects of the present disclosure.

FIG. 3 is a block diagram conceptually illustrating an example of a frame structure in a wireless communication network, in accordance with certain aspects of the present disclosure.

FIG. 4 is a block diagram conceptually illustrating two example subframe formats with the normal cyclic prefix, in accordance with certain aspects of the present disclosure.

FIGS. 5A and 5B are diagrams illustrating examples of 5G icon display for a shared base station based at least in part on a bitmap or list of 5G-available operator networks, in accordance with various aspects of the present disclosure.

FIG. 6 is a diagram illustrating an example of 5G icon display for a shared base station based at least in part on respective 5G frequency lists of one or more operator networks, in accordance with various aspects of the present disclosure.

FIG. 7 is a diagram illustrating an example of 5G icon display for a shared base station based at least in part on stored information, in accordance with various aspects of the present disclosure.

FIG. 8 is a diagram illustrating an example process performed, for example, by a user equipment, in accordance with various aspects of the present disclosure.

### DETAILED DESCRIPTION

A UE may display an icon that indicates which radio access technologies (RATs) the UE can currently use. For example, when the UE identifies an operator network associated with an LTE RAT, and when the UE is configured to use the operator network (e.g., based at least in part on a subscription or a registered operator network status of the UE), the UE may display an LTE icon. In some aspects, the UE may also perform a measurement and may display a signal strength or quality indicator, such as a number of bars. The determination of whether the UE is configured to use an operator network may be based at least in part on an identifier of the operator network, such as a public mobile land network (PLMN) identifier or a similar identifier. For example, when the UE is registered with a registered PLMN corresponding to a particular operator network, the UE may display an icon for the RAT of the particular operator network based at least in part on determining that the particular operator network is associated with the registered PLMN.

A complication may arise when a base station provides access to multiple, different operator networks associated with different RATs. For example, a PLMN of an operator network may not indicate a RAT of the operator network. Additionally, or alternatively, in some market deployments, different operators may have different 5G frequencies while sharing a same base station (e.g., LTE eNB) and/or 4G/LTE frequency. For example, a first operator network may use a first 5G frequency band, and a second operator network provided by the same base station may use a second 5G frequency band. When information regarding the first operator network and the second operator network are provided via the same base station, confusion may occur for a UE which is registered on only one of the operator networks. For example, it may be difficult for the UE to determine whether to display a 5G icon indicating availability of 5G in such a scenario.

Some techniques and apparatuses described herein determine that a base station, associated with a first RAT, is shared between one or more operator networks of a second RAT, and display an icon corresponding to the second RAT based at least in part on a particular operator network, of the one or more operator networks associated with the second RAT, being a registered operator network of the UE and being associated with the second RAT. For example, the UE may determine whether any operator network provided by the base station is associated with a registered PLMN of the UE and uses a 5G RAT, as described in more detail below. When an operator network is associated with the registered PLMN and uses the 5G RAT, the UE may display a 5G icon. In this way, the UE may identify a registered operator network provided by a multi-RAT base station, and may provide an icon accordingly. This may reduce confusion with regard to available RATs, and may be particularly helpful for dual-connectivity UEs, which may use LTE as a fallback for a 5G deployment.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G and/or 4G wireless technologies, aspects of the present disclosure can be applied in other generation-based communication systems, such as 5G and later, including NR technologies.

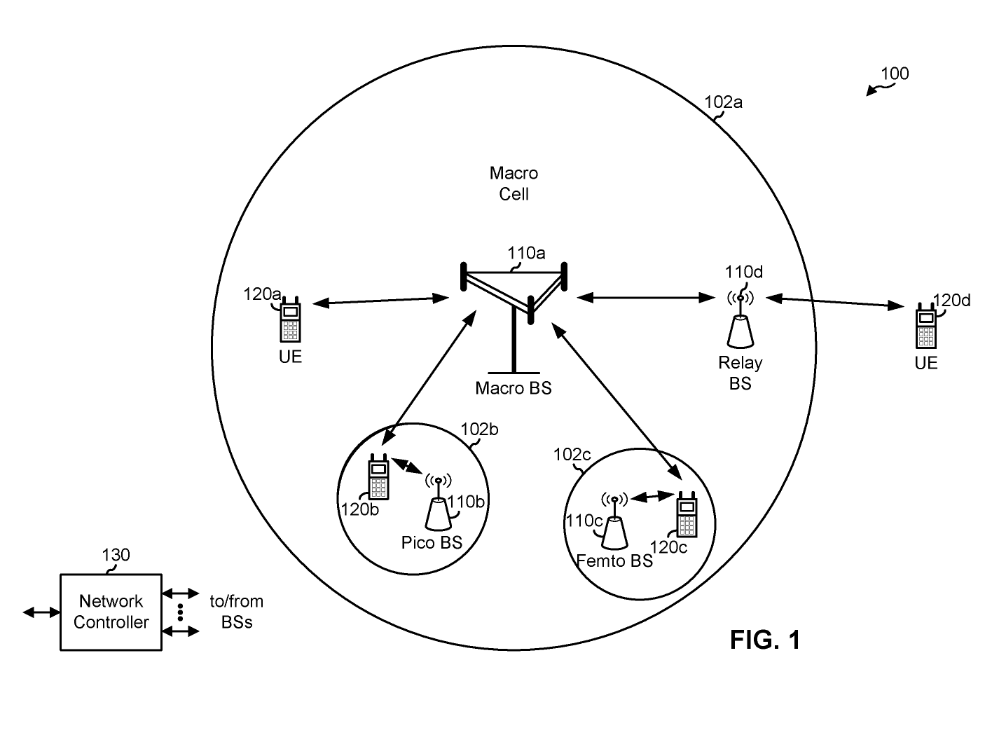

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, etc.

Wireless network 100 may be a heterogeneous network that includes BSs of different types, e.g., macro BSs, pico BSs, femto BSs, relay BSs, etc. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, such as sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed. In some cases, a BS 110 may provide access to multiple, different operator networks associated with respective RATs. For example, a BS 110 may be shared between one or more operator networks of a first RAT (e.g., LTE) and one or more operator networks of a second RAT (e.g., 5G). Each operator network may be associated with a respective identifier (e.g., a PLMN or a similar identifier). In some aspects, a UE 120 may determine that a BS 110, associated with a first radio access technology, is shared between one or more operator networks of a second radio access technology, and/or display an icon corresponding to the second radio access technology based at least in part on a particular operator network, of the one or more operator networks, being a registered operator network of the UE 120 and being associated with the second radio access technology.

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As indicated above, FIG. 1 is provided merely as an example. Other examples are possible and may differ from what was described with regard to FIG. 1.

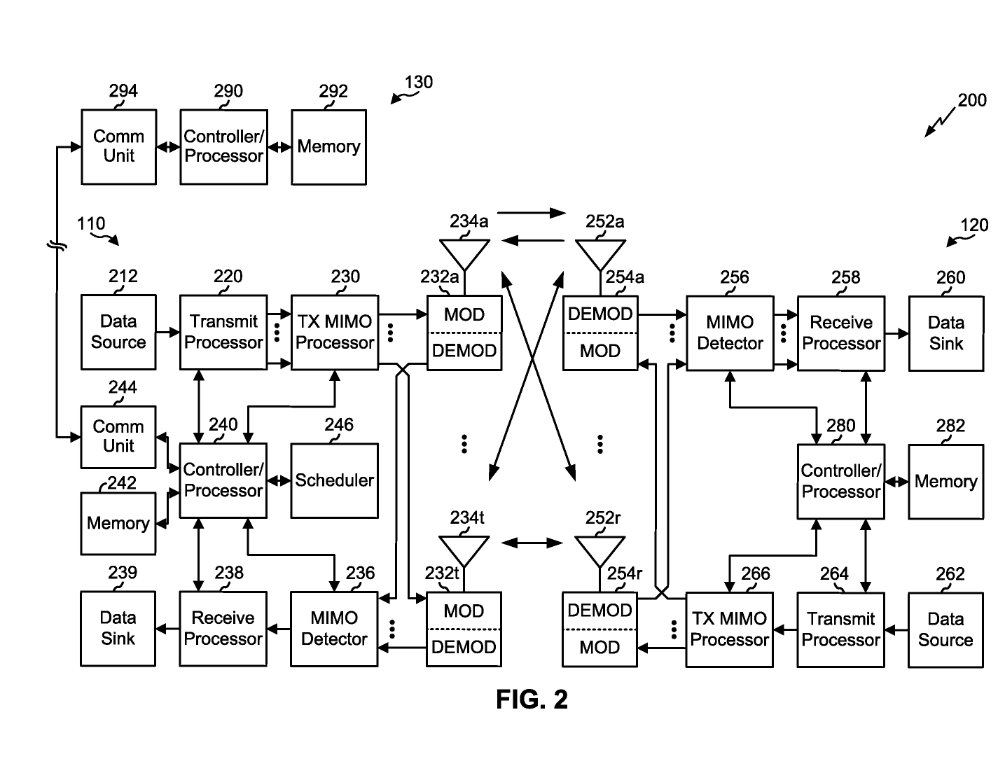

FIG. 2 shows a block diagram of a design of BS 110 and UE 120, which may be one of the base stations and one of the UEs in FIG. 1. BS 110 may be equipped with T antennas 234a through 234t, and UE 120 may be equipped with R antennas 252a through 252r, where in general T>1 and R>1.

At BS 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE and based at least in part on a RAT associated with the BS 110, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to certain aspects described in more detail below, the data may indicate an operator network and/or an identifier of an operator network associated with the BS 110 (e.g., based at least in part on a PLMN and/or the like).

At UE 120, antennas 252a through 252r may receive the downlink signals from BS 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), etc.

On the uplink, at UE 120, a transmit processor 264 may receive and process data from a data source 262 and control information (e.g., for reports comprising RSRP, RSSI, RSRQ, CQI, etc.) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, etc.), and transmitted to BS 110. At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

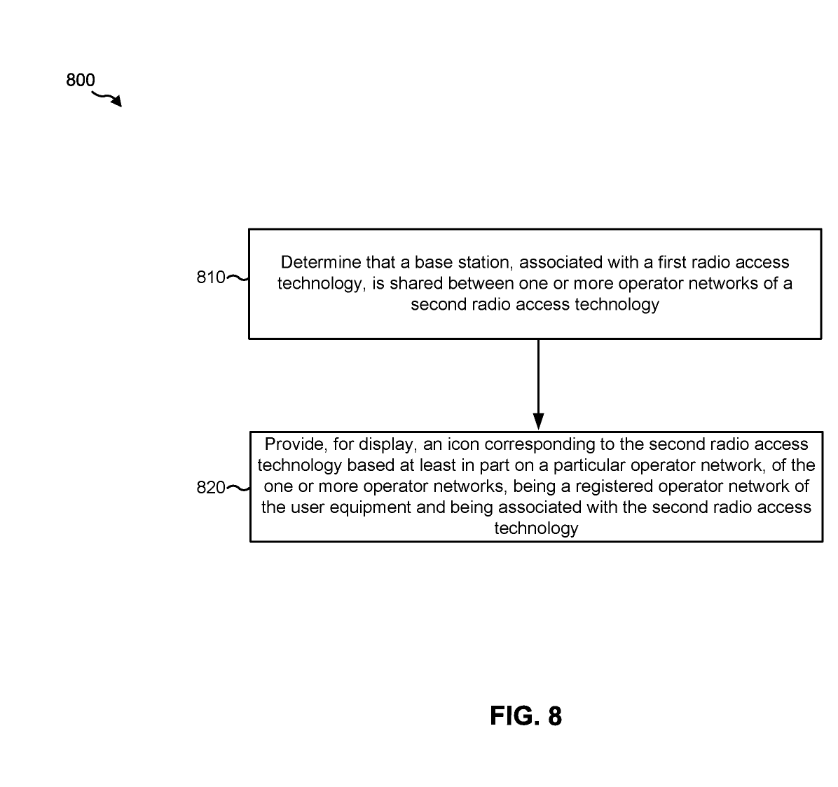

In some aspects, one or more components of UE 120 may be included in a housing. Controllers/processors 240 and 280 and/or any other component(s) in FIG. 2 may direct the operation at BS 110 and UE 120, respectively, to perform 5G icon display for a shared base station. For example, controller/processor 280 and/or other processors and modules at UE 120, may perform or direct operations of UE 120 to perform 5G icon display for a shared base station. For example, controller/processor 280 and/or other controllers/processors and modules at UE 120 may perform or direct operations of, for example, process 800 of FIG. 8 and/or other processes as described herein. In some aspects, one or more of the components shown in FIG. 2 may be employed to perform example process 800 and/or other processes for the techniques described herein. Memories 242 and 282 may store data and program codes for BS 110 and UE 120, respectively. The stored program codes, when executed by controller/processor 280 and/or other processors and modules at UE 120, may cause the UE 120 to perform operations described with respect to process 800 of FIG. 8 and/or other processes as described herein. A scheduler 246 may schedule UEs for data transmission on the downlink and/or uplink.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

In some aspects, UE 120 may include means for determining that a base station (e.g., BS 110), associated with a first radio access technology, is shared between one or more operator networks of a second radio access technology, means for displaying an icon corresponding to the second radio access technology based at least in part on a particular operator network, of the one or more operator networks, being a registered operator network of the UE 120 and being associated with the second radio access technology, means for storing information identifying a cell of the base station and indicating that the particular operator network associated with the second radio access technology is provided by the cell, means for performing a measurement with regard to the particular operator network based at least in part on the information, and with regard to at least one operator network identified by a frequency list provided by the base station via the cell, means for storing information identifying a cell of the base station and indicating that another operator network, of the one or more operator networks associated with the second radio access technology other than the particular operator network, is provided by the cell and is not the registered operator network, means for performing a measurement with regard to at least one operator network identified by a frequency list provided by the base station via the cell, and/or the like. In some aspects, such means may include one or more components of UE 120 described in connection with FIG. 2.

As indicated above, FIG. 2 is provided merely as an example. Other examples are possible and may differ from what was described with regard to FIG. 2.

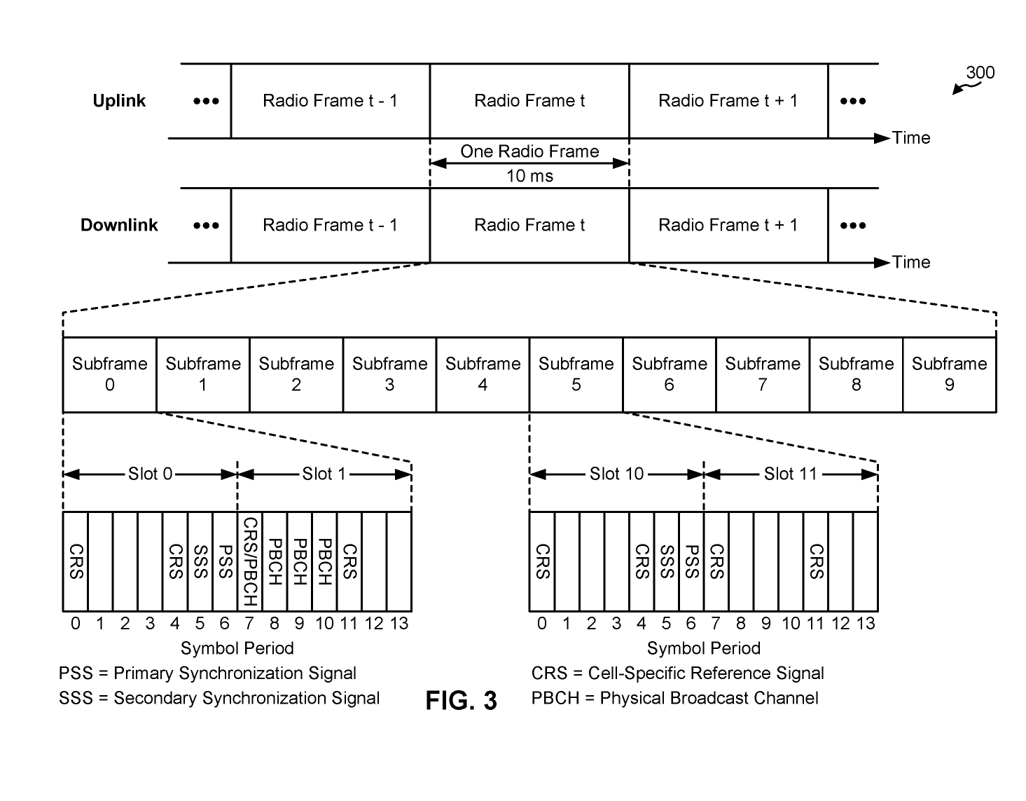

FIG. 3 shows an example frame structure 300 for frequency division duplexing (FDD) in a telecommunications system (e.g., LTE). The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L−1.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol.

In certain telecommunications (e.g., LTE), a BS may transmit a primary synchronization signal (PSS) and a secondary synchronization signal (SSS) on the downlink in the center of the system bandwidth for each cell supported by the BS. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The BS may transmit a cell-specific reference signal (CRS) across the system bandwidth for each cell supported by the BS. The CRS may be transmitted in certain symbol periods of each subframe and may be used by the UEs to perform channel estimation, channel quality measurement, and/or other functions. The BS may also transmit a physical broadcast channel (PBCH) in symbol periods 0 to 3 in slot 1 of certain radio frames. The PBCH may carry some system information. The BS may transmit other system information such as system information blocks (SIBs) on a physical downlink shared channel (PDSCH) in certain subframes. In some aspects, a SIB may identify which operator network(s) are provided by the BS, may indicate frequencies associated with the operator network(s), may indicate a RAT associated with the operator network(s), and/or the like. The BS may transmit control information/data on a physical downlink control channel (PDCCH) in the first B symbol periods of a subframe, where B may be configurable for each subframe. The BS may transmit traffic data and/or other data on the PDSCH in the remaining symbol periods of each subframe.

In other systems (e.g., such as NR or 5G systems), a Node B may transmit these or other signals (e.g., a synchronization signal block, a tracking reference signal, and/or the like) in these locations or in different locations of the subframe.

As indicated above, FIG. 3 is provided merely as an example. Other examples are possible and may differ from what was described with regard to FIG. 3.

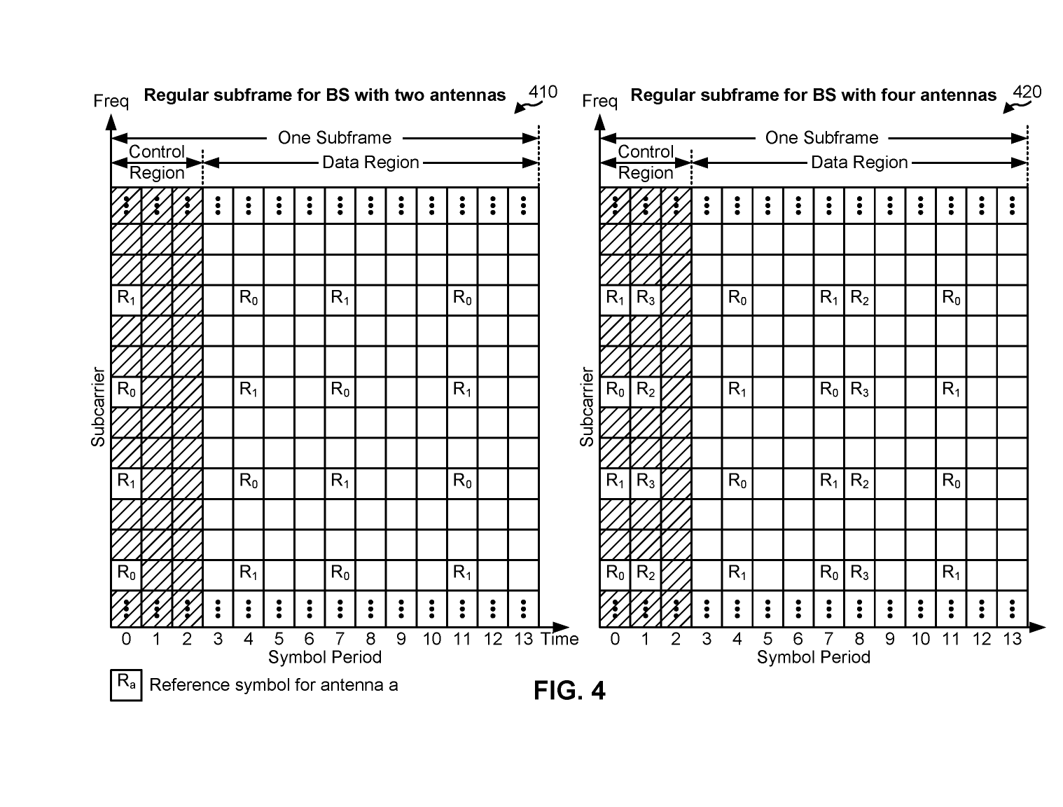

FIG. 4 shows two example subframe formats 410 and 420 with the normal cyclic prefix. The available time frequency resources may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for two antennas. A CRS may be transmitted from antennas 0 and 1 in symbol periods 0, 4, 7, and 11. A reference signal is a signal that is known a priori by a transmitter and a receiver and may also be referred to as a pilot signal. A CRS is a reference signal that is specific for a cell, e.g., generated based at least in part on a cell identity (ID). In FIG. 4, for a given resource element with label Ra, a modulation symbol may be transmitted on that resource element from antenna a, and no modulation symbols may be transmitted on that resource element from other antennas. Subframe format 420 may be used with four antennas. A CRS may be transmitted from antennas 0 and 1 in symbol periods 0, 4, 7, and 11 and from antennas 2 and 3 in symbol periods 1 and 8. For both subframe formats 410 and 420, a CRS may be transmitted on evenly spaced subcarriers, which may be determined based at least in part on cell ID. CRSs may be transmitted on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP Technical Specification (TS) 36.211, entitled “Evolved Universal Terrestrial Radio Access (E-UTRA); Physical Channels and Modulation,” which is publicly available.

An interlace structure may be used for each of the downlink and uplink for FDD in certain telecommunications systems (e.g., LTE). For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where q E {0, . . . , Q−1}.

The wireless network may support hybrid automatic retransmission request (HARQ) for data transmission on the downlink and uplink. For HARQ, a transmitter (e.g., a BS) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering BSs. In some aspects, the serving BS may provide multiple different operator networks and/or RATs, as described elsewhere herein.

While aspects of the examples described herein may be associated with LTE technologies, aspects of the present disclosure may be applicable with other wireless communication systems, such as NR or 5G technologies.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using time division duplexing (TDD). In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using TDD. NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

A single component carrier bandwidth of 100 MHZ may be supported. NR resource blocks may span 12 sub-carriers with a sub-carrier bandwidth of 75 kilohertz (kHz) over a 0.1 ms duration. Each radio frame may include 10 subframes with a length of 10 ms. Consequently, each subframe may have a length of 0.2 ms. Each subframe may indicate a link direction (e.g., DL or UL) for data transmission and the link direction for each subframe may be dynamically switched. Each subframe may include downlink/uplink (DL/UL) data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such central units or distributed units.

The radio access network (RAN) may include a central unit (CU) and distributed units (DUs). A NR BS (e.g., gNB, 5G Node B, Node B, transmit receive point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases, DCells may not transmit synchronization signals. In some cases, DCells may transmit synchronization signals. NR BSs may transmit downlink signals to UEs indicating the cell type. Based at least in part on the cell type indication, the UE may communicate with the NR BS. For example, the UE may determine NR BSs to consider for cell selection, access, handover, and/or measurement based at least in part on the indicated cell type.

As indicated above, FIG. 4 is provided merely as an example. Other examples are possible and may differ from what was described with regard to FIG. 4.

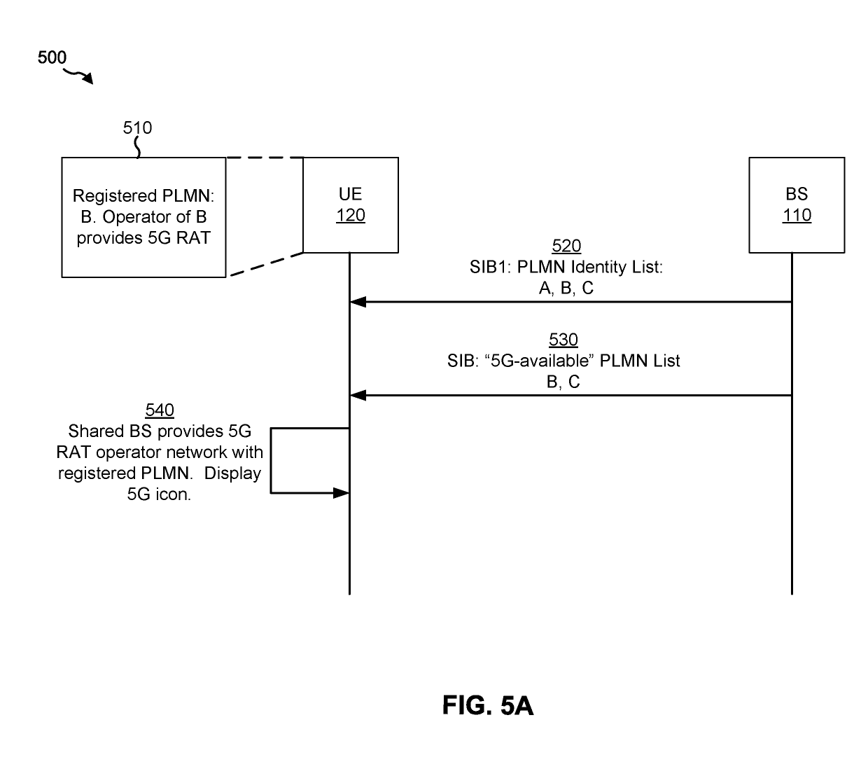

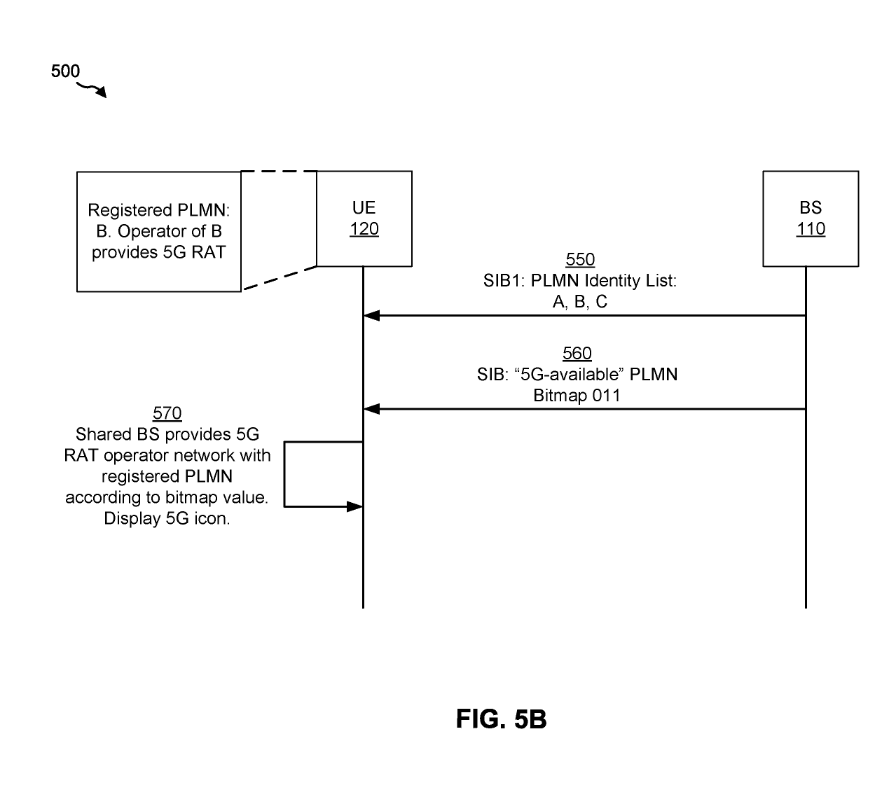

FIGS. 5A and 5B are diagrams illustrating examples 500 of 5G icon display for a shared base station based at least in part on a bitmap or list of 5G-available operator networks, in accordance with various aspects of the present disclosure.

As shown in FIG. 5A, and by reference number 510, a UE 120 may be associated with a registered PLMN identified as B. As further shown, the registered PLMN may correspond to an operator that provides a 5G RAT. In some aspects, the PLMN may not indicate a RAT of an operator network associated with the PLMN. Therefore, when the UE 120 detects an operator network associated with the registered PLMN, the UE 120 may determine the RAT of the operator network associated with the registered PLMN to determine whether an indicator associated with a particular RAT (e.g., a 5G indicator corresponding to a 5G RAT) should be provided for display, as described in more detail below.

As shown by reference number 520, a BS 110 may provide an LTE SIB1 that identifies PLMNs of operator networks provided by the BS 110. For example, the BS 110 may be a shared BS, and may provide access to multiple, different operator networks associated with respective PLMNs. As shown, the BS 110 provides access to networks associated with PLMNs of A, B, and C. Therefore, the BS 110 provides access to an operator network with the registered PLMN B of the UE 120.

As shown by reference number 530, the UE 120 may receive a list indicating which PLMNs, of the operator networks provided by the BS 110, are 5G-available (e.g., use a 5G RAT). Here, the operator networks associated with the PLMNs of B and C use a 5G RAT. As further shown, in some aspects, the list may be provided in system information. For example, in FIG. 5A, the list is provided as part of a SIB. In some aspects, the list may be provided in another fashion (e.g., radio resource control (RRC) signaling, higher-layer signaling, etc.).

As shown by reference number 540, the UE 120 may determine that the BS 110 (e.g., the shared BS) provides an operator network that uses a 5G RAT and that is associated with the registered PLMN B. Accordingly, the UE 120 may display a 5G icon indicating that the UE 120 can use the 5G RAT with regard to the operator network associated with the registered PLMN B. In some aspects, the UE 120 may display the 5G icon. In some aspects, the UE 120 may determine a measurement, and may provide the icon based at least in part on the measurement (e.g., a signal strength measurement, a signal quality measurement, and/or the like). The icon may visually identify that the 5G RAT is available to the UE 120. In this way, the UE 120 determines that a shared BS, associated with multiple different RATs, provides access to an operator network associated with the UE and associated with a 5G RAT and displays a 5G icon accordingly.

FIG. 5B is an example wherein the BS 110 indicates which PLMNs are associated with a 5G RAT based at least in part on a bitmap. As shown in FIG. 5B, the UE 120 is associated with the registered PLMN identified as B. As further shown, the registered PLMN may correspond to an operator that provides a 5G RAT.

As shown by reference number 550, the UE 120 may receive a SIB (e.g., SIB1) indicating that the BS 110 is associated with operator networks having PLMNs of A, B, and C. Note that the UE 120 has a registered PLMN of B, indicating that the UE 120 is associated with the operator network having the PLMN of B.

As shown by reference number 560, the UE 120 may receive information (e.g., system information, a system information block, and/or the like) indicating which PLMNs, of the PLMNs A, B, and C, are associated with a 5G RAT. For example, the UE 120 may receive a bitmap, wherein each value of the bitmap corresponds to one of the PLMNs and indicates whether the corresponding PLMN is associated with a first RAT or a second RAT. For example, a first value (e.g., 0) may indicate that the PLMN A is associated with a first RAT (e.g., LTE). Second and third values (e.g., 1 and 1, respectively) may indicate that the PLMNs B and C are associated with a second RAT (e.g., 5G). In some aspects, the bitmap may include a particular number of values, and a subset of the particular number of values may be relevant to the PLMNs associated with the BS 110. For example, the bitmap may have a set size (e.g., 6 values), and 3 values of the bitmap may correspond to the PLMNs A, B, and C.

As shown by reference number 570, the UE 120 may determine that the BS 110 provides an operator network that is associated with the registered PLMN and that is associated with a 5G RAT. Therefore, the UE 120 may display an icon associated with the 5G RAT. In some aspects, the UE 120 may provide the icon based at least in part on a measurement. In this way, the UE 120 determines that a shared BS, associated with multiple different RATs, provides access to an operator network associated with the UE 120 and associated with a 5G RAT and displays a 5G icon accordingly. Furthermore, by using the bitmap, air interface resources and processor resources are conserved that might otherwise be used to provide information indicating which PLMNs are associated with 5G RATs in a less efficient manner. For example, the bitmap may be more efficient than providing a PLMN identifier of each operator network associated with a 5G RAT.

As indicated above, FIGS. 5A and 5B are provided as examples. Other examples are possible and may differ from what was described with respect to FIGS. 5A and 5B.

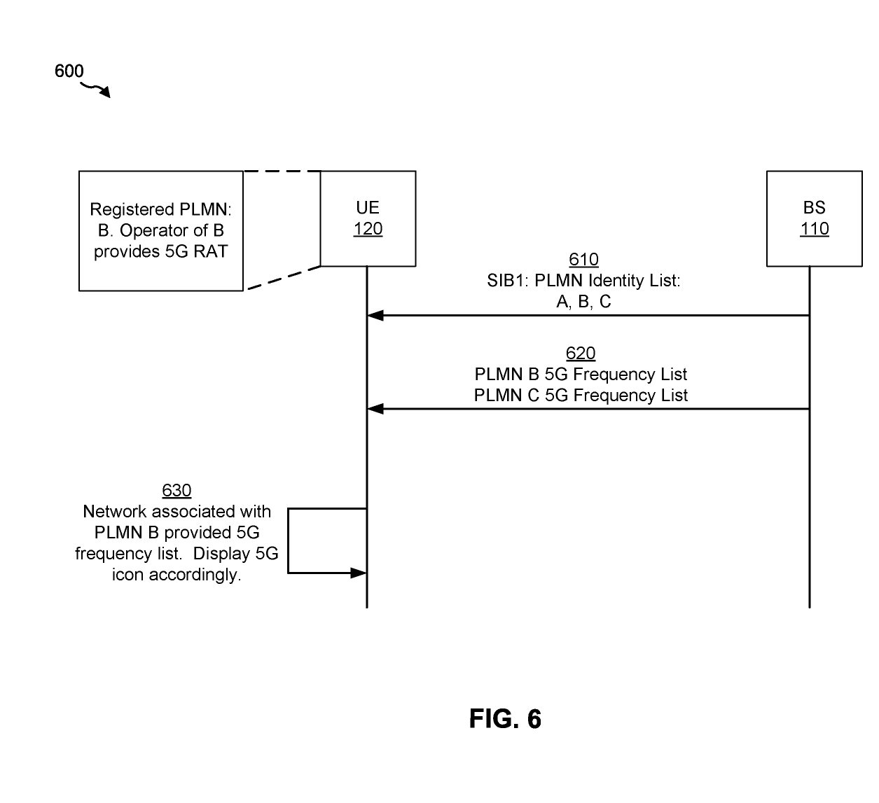

FIG. 6 is a diagram illustrating an example 600 of 5G icon display for a shared base station based at least in part on respective 5G frequency lists of one or more operator networks, in accordance with various aspects of the present disclosure.

As shown in FIG. 6, and as described in more detail in connection with FIGS. 5A and 5B, above, a UE 120 may be associated with a registered PLMN of B, and an operator may provide an operator network associated with the registered PLMN of B and using a 5G RAT.

As shown by reference number 610, and as described in more detail in connection with FIGS. 5A and 5B, a BS 110 may provide system information (e.g., a SIB1) indicating that the BS 110 provides access to operator networks associated with PLMNs of A, B, and C. Note that the UE 120 is registered with regard to an operator network associated with the PLMN of B.

As shown by reference number 620, the BS 110 may provide respective 5G frequency lists for each operator network that is associated with a 5G RAT. For example, a frequency list may identify one or more frequencies associated with the operator network, and may indicate a PLMN associated with the operator network. In some aspects, the BS 110 may only provide 5G frequency lists for operator networks associated with a 5G RAT. Therefore, if a UE 120 receives a 5G frequency list for a particular operator network, the UE 120 may know that the particular operator network is associated with a 5G RAT.

As shown by reference number 630, the UE 120 may determine that the BS 110 provided a 5G frequency list for the operator network associated with the PLMN of B. Therefore, the UE 120 may determine that the operator network associated with the PLMN of B is associated with a 5G RAT, and may accordingly display (or provide for display) an icon associated with the 5G RAT. In some aspects, the UE 120 may display the icon based at least in part on a measurement, as described in more detail elsewhere herein. In some aspects, the UE 120 may be associated with a particular frequency with regard to the 5G RAT. In such a case, the UE 120 may determine whether the 5G frequency list associated with the PLMN of B identifies the particular frequency. If the 5G frequency list identifies the particular frequency, the UE 120 may display (or provide for display) the icon. If the 5G frequency list does not identify the particular frequency, the UE 120 may not display (e.g., provide for display) the icon or may display (e.g., provide for display) a different icon. In this way, the UE 120 determines whether to display a 5G icon based at least in part on a set of 5G frequency lists corresponding to PLMNs of operator networks provided by the BS 110.

As indicated above, FIG. 6 is provided as an example. Other examples are possible and may differ from what was described with respect to FIG. 6.

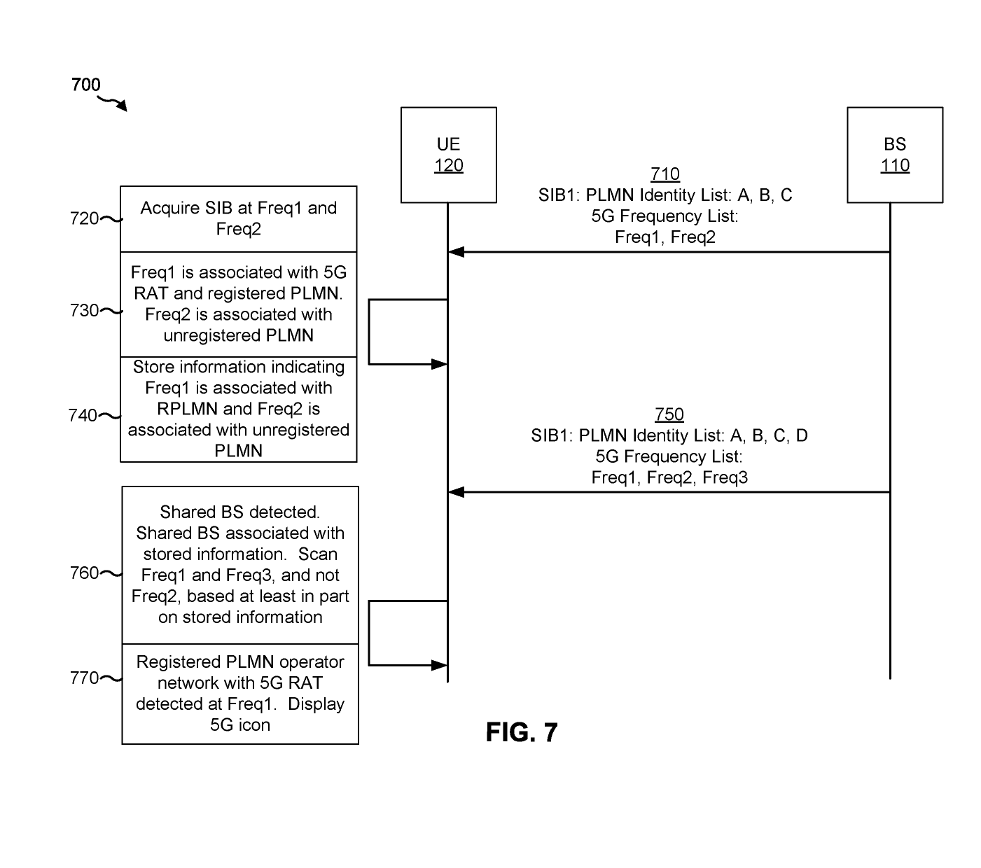

FIG. 7 is a diagram illustrating an example 700 of 5G icon display for a shared base station based at least in part on stored information, in accordance with various aspects of the present disclosure. For the purposes of FIG. 7, and as described in more detail in connection with FIGS. 5A and 5B, above, a UE 120 may be associated with a registered PLMN of B, and an operator may provide an operator network associated with the registered PLMN of B and using a 5G RAT.

As shown by reference number 710, and as described in more detail in connection with FIGS. 5A and 5B, the BS 110 may provide system information (e.g., a SIB1) indicating that the BS 110 provides access to operator networks associated with PLMNs of A, B, and C. Note that the UE 120 is registered with regard to an operator network associated with the PLMN of B.

As further shown, the BS 110 may provide a 5G frequency list indicating frequencies, provided by the BS 110, that are associated with a 5G RAT (e.g., Freq1 and Freq2). In example 700, the 5G frequency list is a single 5G frequency list rather than a plurality of 5G frequency lists that correspond to respective 5G RAT operator networks. Furthermore, the single 5G frequency list identifies frequencies associated with a 5G RAT, rather than PLMNs of operator networks associated with a 5G RAT. Therefore, the UE 120 may need to determine which frequencies are associated with a registered PLMN of the UE 120 and use a 5G RAT, as described in more detail below.

As shown by reference number 720, the UE 120 may acquire NR system information (e.g., a SIB) at Freq1 and Freq2. The UE 120 may acquire the NR system information to identify operator networks of Freq1 and Freq2, and to determine whether either of the operator networks is associated with a registered PLMN B of the UE 120. In some aspects, each frequency may correspond to a cell, and may be associated with a respective cell identifier (e.g., a cell global identity (CGI) and/or the like).

As shown by reference number 730, the UE 120 may determine that Freq1 is associated with a 5G RAT and a registered PLMN of the UE 120. For example, the NR system information of the 5G cell may indicate the PLMN of an operator network at Freq1. The UE 120 may determine that the operator network is associated with the registered PLMN of B based at least in part on the indication. In some aspects, the UE 120 may determine a cell identifier (e.g., an LTE CGI (Cell Global Identity) and/or the like) associated with the cell that provides Freq1.

As shown by reference number 740, the UE 120 may store information indicating that Freq1 is associated with a 5G RAT and a registered PLMN of the UE 120. For example, the UE 120 may store this information in association with a CGI of an LTE cell associated with Freq1 of the 5G RAT. As further shown, in some aspects, the UE 120 may store other information indicating that Freq2 is associated with an unregistered PLMN. By storing the other information, the UE 120 may subsequently conserve resources that would otherwise be used to scan Freq2 at a later time to determine whether Freq2 is associated with a registered PLMN.

In the present example, the UE 120 disconnects and subsequently reconnects to the BS 110. As shown by reference number 750, the BS 110 may provide a SIB identifying PLMNs of operator networks provided by the BS 110. Here, the BS 110 provides operator networks associated with PLMNs of A, B, C, and D, while the UE 120 may still be registered with PLMN B. As further shown, the BS 110 may provide a 5G frequency list indicating that the BS 110 provides 5G RATs at Freq1, Freq2, and Freq3.

As shown by reference number 760, the UE 120 may determine that the BS 110 is a shared BS, and that the BS 110 is associated with information stored by the UE 120 (e.g., the information stored in association with reference number 740, above). Therefore, the UE 120 may scan Freq1 and Freq3, and may not scan Freq2. For example, the stored information may indicate that Freq2 is associated with an unregistered PLMN, so the UE 120 may conserve scanning resources by skipping the scanning of Freq2. Furthermore, the UE 120 may scan Freq1 based at least in part on Freq1 being associated with the registered PLMN (e.g., to determine that Freq1 is still associated with the registered PLMN), and may scan Freq3 based at least in part on Freq3 being a new frequency associated with a 5G RAT. In some aspects, the UE 120 may determine that the BS 110 is associated with the stored information based at least in part on a cell identifier of the BS 110. For example, the UE 120 may perform the scan when the cell identifier matches the stored information and one or more frequencies of the 5G frequency list match the stored information.

As shown by reference number 770, the UE 120 may determine that the operator network of Freq1 is associated with the registered PLMN and the 5G RAT, and may display (or provide for display) the 5G icon accordingly. In this way, the UE 120 displays an icon for a 5G RAT with regard to a shared BS by scanning frequencies associated with a 5G RAT to identify a registered operator network of the UE 120. Thus, functionality of the 5G icon feature is improved for shared BSs, and dual-connectivity performance of the UE 120 may be improved.

As indicated above, FIG. 7 is provided as an example. Other examples are possible and may differ from what was described with respect to FIG. 7.

FIG. 8 is a diagram illustrating an example process 800 performed, for example, by a UE, in accordance with various aspects of the present disclosure. Example process 800 is an example where a UE (e.g., UE 120) performs 5G icon display for a shared base station.

As shown in FIG. 8, in some aspects, process 800 may include determining that a base station, associated with a first radio access technology, is shared between one or more operator networks of a second radio access technology (block 810). For example, the UE may determine that a base station, associated with a first RAT (e.g., LTE and/or the like) is shared between one or more operator networks of a second RAT (e.g., New Radio or 5G and/or the like). In some aspects, the UE may perform this determination based at least in part on receiving system information (e.g., a SIB and/or the like) identifying multiple operator networks and/or based at least in part on information indicating that the BS is associated with operator networks corresponding to two or more RATs (e.g., a 5G frequency list and/or the like).

As shown in FIG. 8, in some aspects, process 800 may include providing, for display, an icon corresponding to the second radio access technology based at least in part on a particular operator network, of the one or more operator networks, being a registered operator network of the user equipment and being associated with the second radio access technology (block 820). For example, the UE may provide an icon corresponding to the second RAT (e.g., 5G) based at least in part on a particular operator network being a registered operator network of the UE and being associated with the second RAT. In some aspects, the UE may provide the icon based at least in part on a measurement, as described in more detail elsewhere herein. In this way, the UE improves functionality of the 5G icon feature and reduces error of the 5G icon feature for dual-connectivity scenarios and shared BSs.

In some aspects, the first radio access technology is a Long Term Evolution radio access technology and the second radio access technology is a 5th Generation or New Radio radio access technology. In some aspects, the determination is based at least in part on system information identifying the one or more operator networks and an operator network of the second radio access technology. In some aspects, the particular operator network is identified from a list of the one or more operator networks, wherein the list indicates that the one or more operator networks are associated with the second radio access technology. In some aspects, the list indicates that the one or more operator networks are associated with the second radio access technology based at least in part on bit values corresponding to the one or more operator networks in a system information block. In some aspects, the particular operator network is identified as associated with the second radio access technology based at least in part on corresponding frequency lists of the one or more operator networks, wherein the corresponding frequency lists indicate whether the one or more operator networks are associated with the second radio access technology.

In some aspects, the particular operator network is identified based at least in part on respective system information for the one or more operator networks, wherein the respective system information is determined by searching respective frequencies associated with the one or more operator networks. In some aspects, the UE may store information identifying a cell of the base station and indicating that the particular operator network associated with the second radio access technology is provided by the cell.

In some aspects, the UE may perform a measurement with regard to the particular operator network based at least in part on the information, and with regard to at least one operator network identified by a frequency list provided by the base station via the cell, wherein the measurement is performed after the information has been stored and based at least in part on reconnecting to the cell.

In some aspects, the UE may store information identifying a cell of the base station and indicating that another operator network, of the one or more operator networks associated with the second radio access technology other than the particular operator network, is provided by the cell and is not the registered operator network.

In some aspects, the UE may perform a measurement with regard to at least one operator network identified by a frequency list provided by the base station via the cell, wherein the measurement is performed after the information has been stored and based at least in part on reconnecting to the cell, and wherein the measurement is not performed for the other operator network.

In some aspects, the icon is displayed or provided for display based at least in part on a measurement regarding the particular operator network. In some aspects, the icon visually identifies that the second radio access technology is available to the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment, comprising:
determining that a base station, associated with a first radio access technology, is shared between one or more operator networks of a second radio access technology; and
displaying an icon corresponding to the second radio access technology based at least in part on a particular operator network, of the one or more operator networks, being a registered operator network of the user equipment and being associated with the second radio access technology.

2. The method of claim 1, wherein the first radio access technology is a Long Term Evolution radio access technology and the second radio access technology is a 5th Generation or New Radio radio access technology.

3. The method of claim 1, wherein the determination is based at least in part on system information identifying the one or more operator networks and an operator network of the second radio access technology.

4. The method of claim 1, wherein the particular operator network is identified from a list of the one or more operator networks, wherein the list indicates that the one or more operator networks are associated with the second radio access technology.

5. The method of claim 4, wherein the list indicates that the one or more operator networks are associated with the second radio access technology based at least in part on bit values corresponding to the one or more operator networks in a system information block.

6. The method of claim 1, wherein the particular operator network is identified as associated with the second radio access technology based at least in part on corresponding frequency lists of the one or more operator networks, wherein the corresponding frequency lists indicate whether the one or more operator networks are associated with the second radio access technology.

7. The method of claim 1, wherein the particular operator network is identified based at least in part on respective system information for the one or more operator networks, wherein the respective system information is determined by searching respective frequencies associated with the one or more operator networks.

8. The method of claim 1, further comprising:
storing information identifying a cell of the base station and indicating that the particular operator network associated with the second radio access technology is provided by the cell.

9. The method of claim 8, further comprising:
performing a measurement with regard to the particular operator network based at least in part on the information, and with regard to at least one operator network identified by a frequency list provided by the base station via the cell,
wherein the measurement is performed after the information has been stored and based at least in part on reconnecting to the cell.

10. The method of claim 1, further comprising:
storing information identifying a cell of the base station and indicating that another operator network, of the one or more operator networks associated with the second radio access technology other than the particular operator network, is provided by the cell and is not the registered operator network.

11. The method of claim 10, further comprising:
performing a measurement with regard to at least one operator network identified by a frequency list provided by the base station via the cell,
wherein the measurement is performed after the information has been stored and based at least in part on reconnecting to the cell, and
wherein the measurement is not performed for the other operator network.

12. The method of claim 1, wherein the icon is displayed based at least in part on a measurement regarding the particular operator network.

13. The method of claim 1, wherein the icon visually identifies that the second radio access technology is available to the user equipment.

14. A user equipment for wireless communication, comprising:
memory; and
one or more processors operatively coupled to the memory, the memory and the one or more processors configured to:
determine that a base station, associated with a first radio access technology, is shared between one or more operator networks of a second radio access technology; and
display an icon corresponding to the second radio access technology based at least in part on a particular operator network, of the one or more operator networks, being a registered operator network of the user equipment and being associated with the second radio access technology.

15. The user equipment of claim 14, wherein the first radio access technology is a Long Term Evolution radio access technology and the second radio access technology is a 5th Generation or New Radio radio access technology.

16. The user equipment of claim 14, wherein the determination is based at least in part on system information identifying the one or more operator networks and an operator network of the second radio access technology.

17. The user equipment of claim 14, wherein the particular operator network is identified from a list of the one or more operator networks, wherein the list indicates that the one or more operator networks are associated with the second radio access technology.

18. The user equipment of claim 17, wherein the list indicates that the one or more operator networks are associated with the second radio access technology based at least in part on bit values corresponding to the one or more operator networks in a system information block.

19. The user equipment of claim 14, wherein the particular operator network is identified as associated with the second radio access technology based at least in part on corresponding frequency lists of the one or more operator networks, wherein the corresponding frequency lists indicate whether the one or more operator networks are associated with the second radio access technology.

20. The user equipment of claim 14, wherein the particular operator network is identified based at least in part on respective system information for the one or more operator networks, wherein the respective system information is determined by searching respective frequencies associated with the one or more operator networks.

21. The user equipment of claim 14, wherein the icon is displayed based at least in part on a measurement regarding the particular operator network.

22. The user equipment of claim 14, wherein the icon visually identifies that the second radio access technology is available to the user equipment.

23. A non-transitory computer-readable medium storing instructions for wireless communication, the instructions comprising:
one or more instructions that, when executed by one or more processors of a user equipment, cause the one or more processors to:
determine that a base station, associated with a first radio access technology, is shared between one or more operator networks of a second radio access technology; and
display an icon corresponding to the second radio access technology based at least in part on a particular operator network, of the one or more operator networks, being a registered operator network of the user equipment and being associated with the second radio access technology.

24. The non-transitory computer-readable medium of claim 23, wherein the first radio access technology is a Long Term Evolution radio access technology and the second radio access technology is a 5th Generation or New Radio radio access technology.

25. The non-transitory computer-readable medium of claim 23, wherein the determination is based at least in part on system information identifying the one or more operator networks and an operator network of the second radio access technology.

26. The non-transitory computer-readable medium of claim 23, wherein the particular operator network is identified from a list of the one or more operator networks, wherein the list indicates that the one or more operator networks are associated with the second radio access technology.

27. An apparatus for wireless communication, comprising:
means for determining that a base station, associated with a first radio access technology, is shared between one or more operator networks of a second radio access technology; and
means for displaying an icon corresponding to the second radio access technology based at least in part on a particular operator network, of the one or more operator networks, being a registered operator network of the apparatus and being associated with the second radio access technology.

28. The apparatus of claim 27, wherein the first radio access technology is a Long Term Evolution radio access technology and the second radio access technology is a 5th Generation or New Radio radio access technology.

29. The apparatus of claim 27, wherein the determination is based at least in part on system information identifying the one or more operator networks and an operator network of the second radio access technology.

30. The apparatus of claim 27, wherein the particular operator network is identified from a list of the one or more operator networks, wherein the list indicates that the one or more operator networks are associated with the second radio access technology.
